(19) United States
(12) Patent Application Publication
(10) Pub. No.: US 2014/0290906 A1
(43) Pub. Date: Oct. 2, 2014

(54) COOLING DEVICE

(71) Applicants: Gerben Krijnen, Loosdrecht (NL); Lambertus Krijnen, Kortenhoef (NL); Simon Timotheus Portengen, Utrecht (NL); Robert Kisslinger, Munchen (DE)

(72) Inventors: Gerben Krijnen, Loosdrecht (NL); Lambertus Krijnen, Kortenhoef (NL); Simon Timotheus Portengen, Utrecht (NL); Robert Kisslinger, Munchen (DE)

(73) Assignee: ICEK 9000 B.V., Loosedrecht (NL)

(21) Appl. No.: 14/239,305

(22) PCT Filed: Aug. 17, 2012
(86) PCT No.: PCT/NL2012/050578

§ 371 Date: Apr. 9, 2014

(30) Foreign Application Priority Data
Aug. 17, 2011 (NL) 2007273
Feb. 3, 2012 (NL) 2008226
Apr. 16, 2012 (NL) 2008642

(51) Int. Cl. B67D 3/00

(52) U.S. Cl. CPC B67D 3/0009; B67D 3/0022
USPC 165/63

(57) ABSTRACT

A cooling device, provided with a coolant circuit for cooling a volume, such as a cold store, or an arrangement, such as a beverage dispensing unit, includes a pump for pumping a coolant into the coolant circuit, and a heat emission member for emitting heat absorbed by the coolant circuit from the volume or the arrangement, wherein the heat emission member is in heat exchanging communication with an evaporator of the refrigerant circuit, the refrigerant circuit being a different circuit than the coolant circuit, wherein the heat emission member of the coolant circuit and the evaporator of the refrigerant circuit are connected in a heat exchanging manner via a heat conducting substance.

The invention relates to a cooling device, provided with a coolant circuit for cooling a volume, such as a cold store, or an arrangement, such as a beverage dispensing unit, comprising a pump for pumping a coolant through the coolant circuit, and a heat emission member for emitting heat absorbed by the coolant circuit from the volume or the arrangement.

Such a cooling device is known from for example U.S. Pat. No. 5,996,842. This publication describes a device for dispensing cold beverages, especially syrup, provided with a cold metal plate arranged around the beverage dispensing unit, that is cooled by ice present on the metal plate. The beverage dispensing lines are embedded in the cold metal plate, such that the beverage to be transported through the beverage dispensing lines is dispensed to the user. Coolant lines are embedded in the cold metal plate, through which a coolant flows, such that the cold metal plate and the beverage dispensing lines are further cooled. Such a system wherein coolant is used to cool a volume or an arrangement is advantageous for transporting coolant along a relatively long distance, because relatively small energy losses occur, provided the transport lines are sufficiently isolated.

A disadvantage of such a cooling device is, that in circumstances wherein a relatively high degree of cooling is required, the cooling device consumes relatively a lot of space. Especially in situations wherein this space is not or limitedly available, such as with cooling of a beverage dispensing unit in a bar, this is disadvantageous. Another disadvantage of such a cooling device is that it consumes relatively a lot of energy.

It is an object of the invention to provide a cooling device, that consumes less space in circumstances wherein relatively a high degree of cooling is required.

It is a further object of the invention to provide a cooling device that has a relatively low energy consumption.

Hereto the cooling device according to the invention is characterized in that the heat emission member is in heat exchanging communication with an evaporator of a refrigerant circuit, the refrigerant circuit being a different circuit than the coolant circuit, wherein the heat emission member of the coolant circuit and the evaporator of the refrigerant circuit are connected in a heat exchanging manner by means of a heat conducting substance. The refrigerant circuit therein is capable of achieving lower temperatures than the coolant circuit. An advantageous fluid heat conducting substance is for example glycol. An advantageous solid heat conducting substance can for example in an advantageous manner comprise a metal with a relatively high degree of thermal conductivity, such as aluminum. Preferably this metal is comprised by a metal body in the shape of a massive block or otherwise. When using such a metal block, the evaporator and the heat emission member can be embedded in the block in an advantageous manner when producing such a block. Additionally, it is conceivable that the heat conducting substance comprises a fluid or gas. In the case of using a fluid or a gas it is of importance that these substances are stored in a body suitable for that purpose.

The body formed from a solid heat conducting substance, as well as a body with a fluid or a gas as a heat conducting substance will be denoted hereafter with the term ‘cooling block’.

Because the heat emission member is in heat exchanging communication with an evaporator of the refrigerant circuit, the cooling device can be constructed more compactly, since, at a similar size, the refrigerant circuit has a higher cooling capacity. As the heat emission member of the coolant circuit and the evaporator of the refrigerant circuit are connected by means of a heat conducting substance, the efficiency of the thermal transfer from the coolant circuit to the refrigerant circuit is further increased, as a result of which the cooling device is more energy efficient. The mere use of a refrigerant circuit for cooling a volume or arrangement would pose several disadvantages, such as a relatively high energy consumption.

A further embodiment relates to a cooling device, wherein the heat conducting substance comprises a metal body in which the heat emission member and the evaporator are embedded, the metal of the metal body being configured for conducting heat from the heat emission member to the evaporator. Such a metal body can be handled well, especially during assembly of the cooling device, and provides for good heat conduction.

Preferably, the metal body is made of aluminum. By using aluminum that has a relatively high degree of thermal conductivity the heat transfer is further improved. Furthermore, aluminum has a relatively low density. By using a casting process a larger contact surface between the aluminum body and the heat emission member of the coolant circuit on the one hand and the evaporator of the refrigerant circuit on the other hand is achieved. However, it is also conceivable that a substance with a lower degree of thermal conductivity is used, for example in case it is desirable that heat transfer between the coolant circuit and the refrigerant circuit takes place at a lower rate, in order to create a certain amount of buffering functionality in the cooling device, in the sense that the heat conducting substance changes temperature relatively less quickly at a change of temperature of the refrigerant circuit of the heat emission member. Additionally considerations as to the weight of the cooling block can be of importance when selecting a heat conducting substance.

Another embodiment relates to a cooling device, wherein the evaporator comprises duct parts contained in the metal body, which duct parts are made of stainless steel. The stainless steel ducts parts and the metal body allow for good heat exchange. Furthermore, such stainless steel parts can also be used when the heat conducting substance comprises a fluid.

An embodiment relates to a cooling device, wherein, during use, the heat conducting substance is suspended in a water body of a water-containing tank, in such a way that the water is cooled by the heat conducting substance. The water may advantageously function as a heat/cold buffer, especially when the heat conducting substance is not actively cooled by the evaporator. Fluids having similar physical properties can also be used, if desired, such as glycol. Water, however, is cheap, non-poisonous and readily available, and allows the formation of ice on the heat conducting substance, which can act as a further heat/cold buffer.

In an embodiment, the coolant circuit is configured to cool a beverage dispensing unit.

Another embodiment concerns a cooling device, wherein the coolant circuit is configured to distribute coolant at different temperatures to different volumes or arrangements. This is very advantageous in a drinks establishment setting, wherein optimum temperatures for drinks may differ.

To this end, the coolant circuit may comprise several duct parts, a duct part for delivering coolant to be cooled to the heat emission member, this duct part branching off into a plurality of ducts, wherein the heat emission member comprises a plurality of heat emission member parts corresponding to the plurality of branched-off duct parts, each heat emission member part being associated with one of the branched-off duct parts, the heat emission member parts having a different degree of heat exchange with the heat conducting substance, such that the coolant in the duct parts is cooled to different temperatures by the heat conducting substance. This is an effective embodiment for achieving different temperatures of e.g. arrangements in the form of beverage dispensing units, such as beer taps.

The different degree of heat exchange can be advantageously achieved by configuring the ducts parts to be the heat emission member parts by letting them directly emit heat to the heat conducting substance, wherein the total surface area of the duct parts exchanging heat with the heat conducting substance differs to obtain coolant having different temperatures. The different total surface area can be achieved by a different duct diameter, or duct length.

A further embodiment relates to a cooling device, wherein one duct part of the plurality of duct parts delivers coolant to a first beverage dispensing unit to be cooled at a first temperature, and another duct part of the plurality of duct parts delivers coolant to a second beverage dispensing unit to be cooled at a second temperature. E.g. beer taps can be cooled at different temperatures, suitable for the type of beer being tapped.

Advantageously, the first temperature is above 0° C., and the second temperature is below 0° C., such as approximately −7° C.

Another embodiment relates to a cooling device, wherein the beverage dispensing unit is connected to a beverage supply duct, the beverage supply duct being at least partly arranged in the water body of the water-containing tank, such that the beverage is cooled by the water body. Thus, further energy savings are achieved.

An advantageous embodiment relates to a cooling device, wherein, during use, a heating element is arranged in the water body, the heating element being connected to a part of the refrigerant circuit containing hot fluid or gas, in such a way that, when ice is formed on the heat conducting substance due to freezing water, the heating element can be activated to raise the temperature of the water using heat from the refrigerant circuit in order to cause the ice to thaw. By doing so, even higher energy savings can be achieved, by making good use of available heat, especially ‘waste heat’.

Another embodiment concerns a cooling device, wherein the heat conducting substance is a vessel comprising a heat conducting fluid, such as glycol. Such a vessel with a fluid having beneficial thermal properties can also be used, as an alternative to a metal body.

A further embodiment relates to a cooling device, wherein a carbonator is arranged in the heat conducting substance, the carbonator being connected to a beverage supply duct and a CO2-supply duct, and a discharge for discharging the carbonated beverage after carbonation in the carbonator, wherein the carbonator is cooled by the heat conducting substance. As carbonation preferably takes places at lower temperatures, the heat conducting substance can be advantageously used for that purpose.

A yet further embodiment concerns a cooling device, wherein the coolant circuit is provided with transport taps and service taps. The presence of these taps has as an advantage that the cooling device can be connected relatively easily to existing cooling devices. This is also known as “retro-fitting”.

Preferably, the pump is of the DC-type. This type of pump is relatively efficient compared to a pump of the AC-type, which furthermore decreases the cooling device's energy consumption.

In another embodiment, the compressor or pump is frequency-controlled. A frequency-controlled compressor or pump also contributes to a further reduction of the cooling device's energy consumption. As the person skilled in the art will understand, it is also possible to use an energy-efficient rpm-controlled pump instead of a frequency-controlled pump. The flow rate of such pumps is preferably linearly dependent on the difference between the desired temperature of the to-be-cooled substance and the actual temperature thereof.

The diameter of the coolant circuit ducts is preferably more than 10 mm, more preferably more than approximately 12 mm. The mentioned diameter of the ducts of the coolant circuit is especially advantageous for cooling a beer tap.

Besides, it is advantageous to pressurize the coolant circuit in such a way that use can be made of a relatively energy-efficient ‘closed water circuit pump’. Additionally due to the use of such a pump the coolant can be pumped around relatively easily, especially when a relatively large height difference is present between the substance to be cooled and the cooling device.

Other cooling devices are known from patent publications DE 8512793, US 2005/097907, U.S. Pat. No. 2,282,627, DE 4031777 and U.S. Pat. No. 2,612,357. However, these devices do not simultaneously employ a refrigerant circuit as well as a coolant circuit, wherein these circuits exchange heat and the refrigerant circuit is used to achieve cooling of a coolant circuit or/via a heat-conducting substance, the refrigerant circuit therein being capable of achieving lower temperatures than the coolant circuit.

### DETAILED DESCRIPTION

Exemplary embodiments of a cooling device according to the invention will be elucidated further by means of example with reference to the accompanying figures.

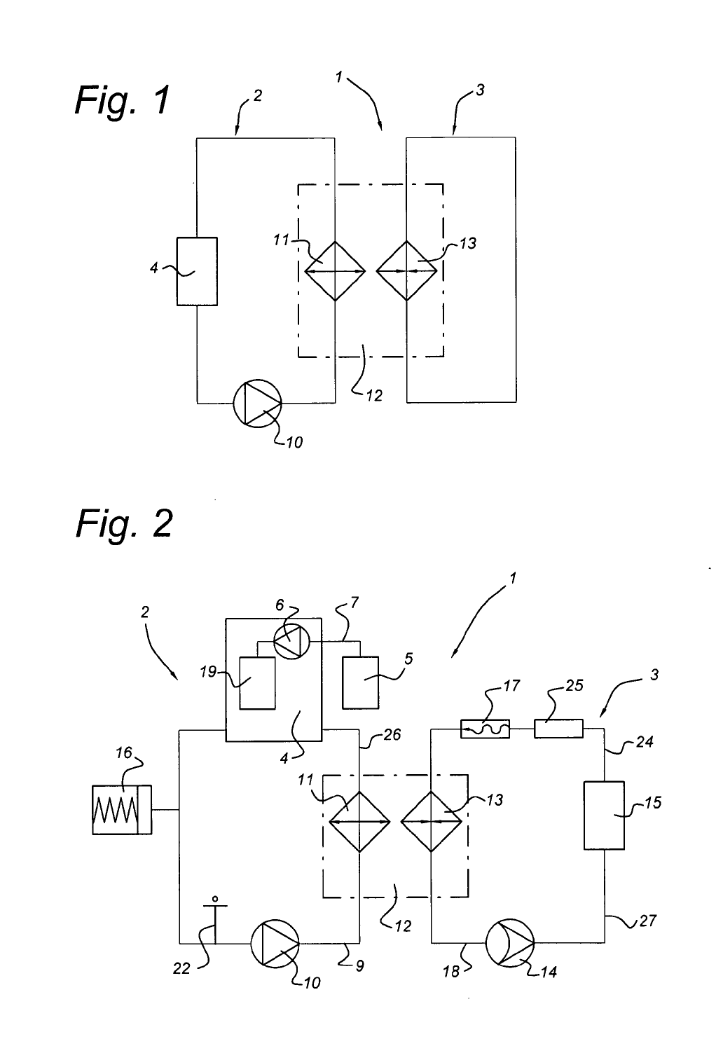

FIG. 1 shows a schematic view of a first exemplary embodiment of a cooling device according to the invention,

FIG. 2 shows a schematic view of a first exemplary embodiment of a cooling device according to the invention for use with a beverage dispensing arrangement,

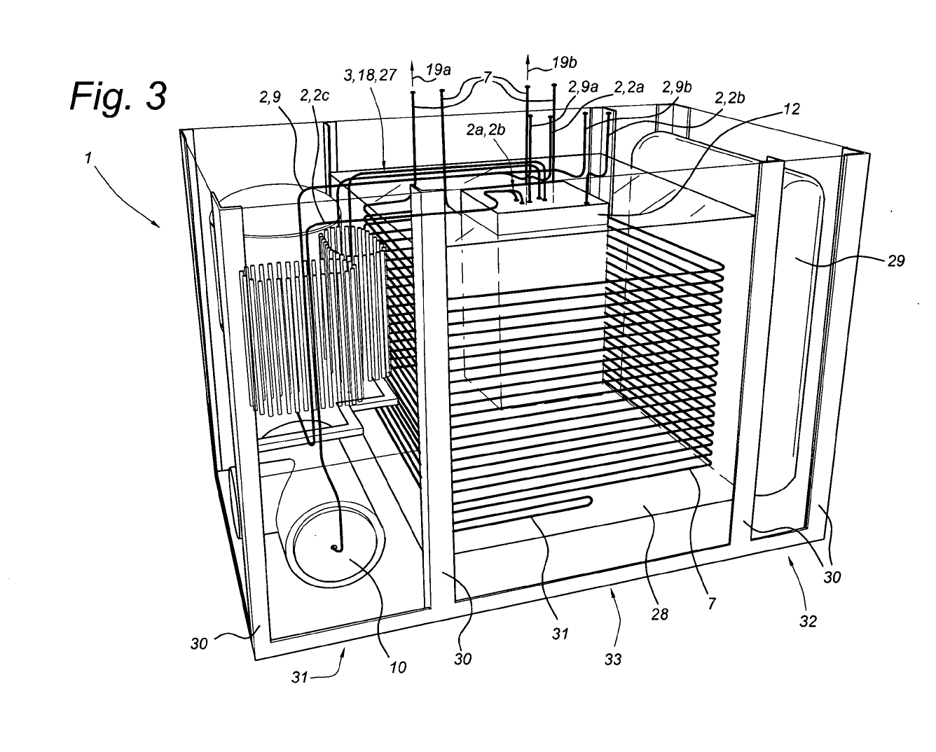

FIG. 3 shows a cut-away perspective view of a second exemplary embodiment of a cooling device according to the invention wherein two beverage dispensing units can be connected for dispensing beverages having different temperatures,

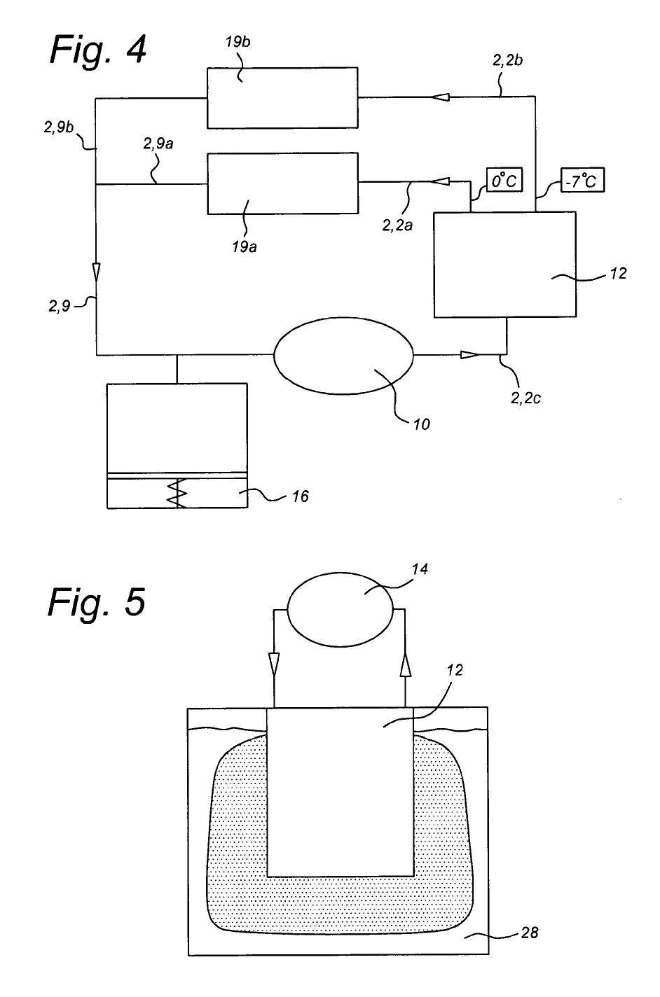

FIG. 4 shows a schematic view of a coolant circuit according to the second exemplary embodiment with beverage dispensing units that are capable of dispensing beverages at different temperatures,

FIG. 5 shows a schematic view of the heat exchanger as used in the cooling device according to the second exemplary embodiment,

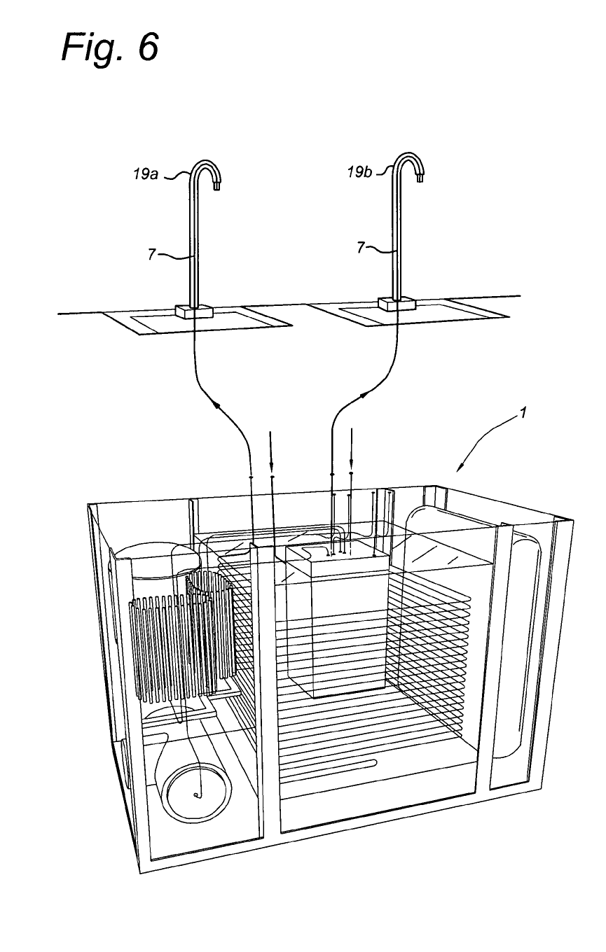

FIG. 6 shows a schematic view of a cooling device according to the second exemplary embodiment wherein two beverage dispensing units are shown that are capable of dispensing beverages at different temperatures,

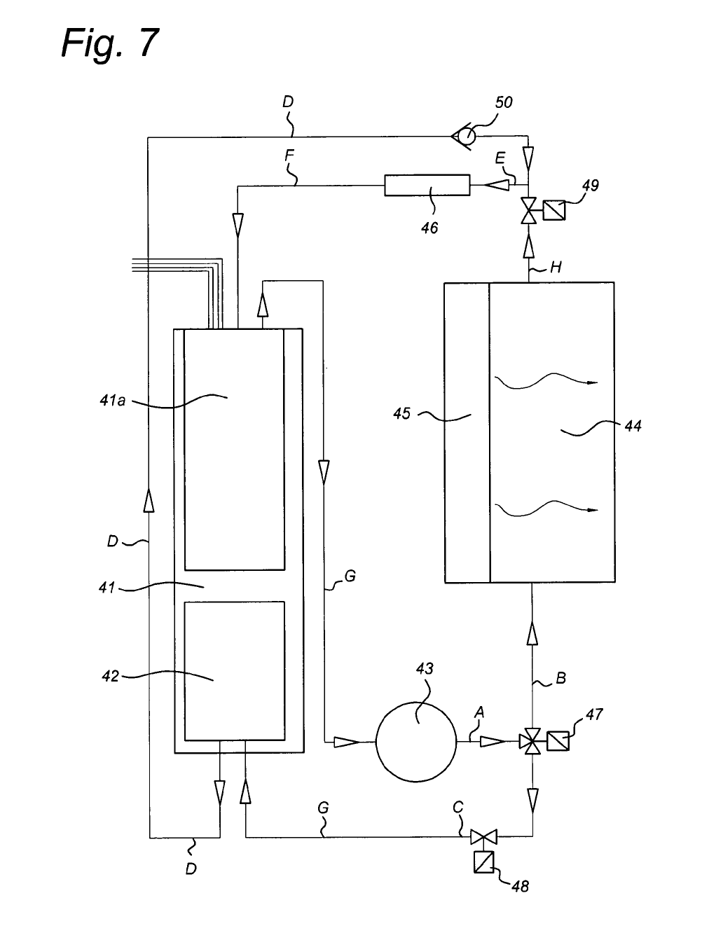

FIG. 7 shows a schematic view of a cooling device wherein the refrigerant circuit is arranged for melting away excess ice from the cooling block, and

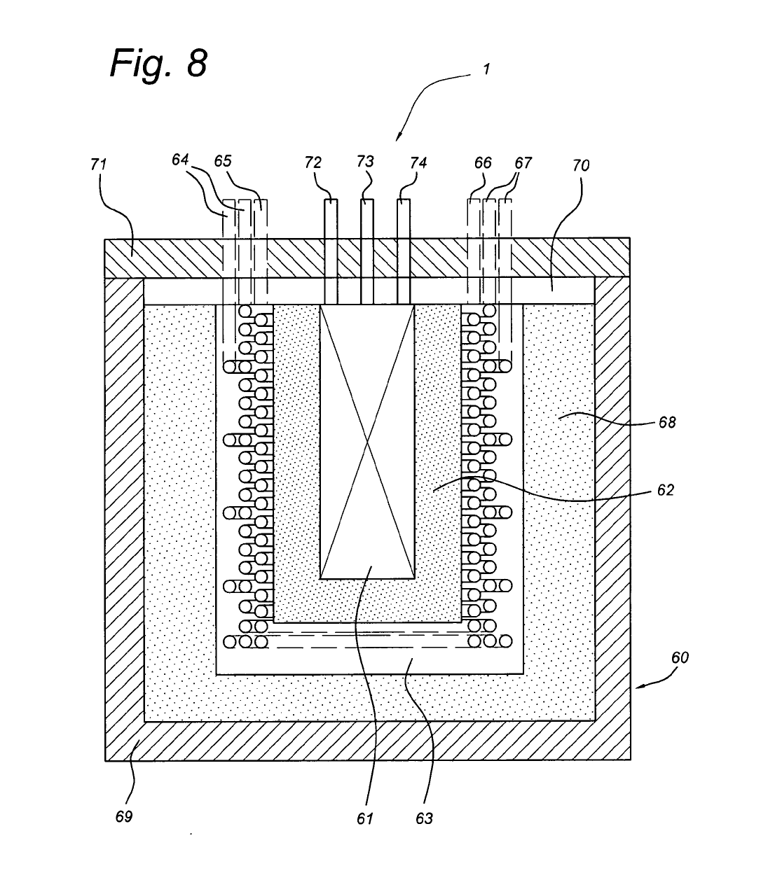

FIG. 8 schematically shows another exemplary embodiment of the cooling device with the cooling block being provided with a carbonator.

FIG. 1 shows a schematic view of a first exemplary embodiment of a cooling device according to the invention with a coolant circuit 2 for cooling an arrangement (or volume) 4, and a refrigerant circuit 3. Furthermore, a pump 10 for pumping coolant and a heat emission member 11 are provided in the coolant circuit 2, which heat emission member 11 transfers the heat absorbed at the arrangement 4 to an evaporator 13 in the refrigerant circuit 3. The heat emission member 11 is part of a schematically depicted heat conducting substance in the form of, for instance, a cooling block 12 (for example made of a heat conducting material such as aluminum).

FIG. 2 shows a schematic view of an embodiment of the cooling device 1 with a coolant circuit 2 and a refrigerant circuit 3 for cooling a beverage dispensing arrangement 4. In an exemplary embodiment the beverage dispensing arrangement 4 comprises a beverage dispensing unit 19 and a pump 6 for pumping a beverage through a fluid duct 7 from a beverage barrel 5 to the beverage dispensing unit 19. The fluid duct 7 is preferably provided with isolation of the type commonly used for isolating ducts having a sub-zero temperature during use. The beverage can for example comprise beer, wherein the beverage barrel 5 is a beer barrel, and the beverage dispensing unit a beer tap.

In the embodiment as shown, the beverage pump 6 and the beverage dispensing unit 19 are cooled with the help of a coolant circuit 2. In a further embodiment, however, only the beverage dispensing unit 19 is cooled, and the coolant circuit 2 is configured in such a way that ice is formed on the beverage dispensing unit 19 from (condensed) moisture originating from ambient air. Thus, when using beer as a beverage, a “beer pillar”” with ice is created.

This coolant circuit 2 comprises a coolant, for example a mixture of water and glycol, wherein the glycol is for example produced from propylene. The coolant circuit 2 comprises a supply duct 26 for transporting coolant through the coolant circuit 2 from the heat emission member 11 to the arrangement 4, and a return duct 9 for transporting coolant, by means of a pump 10, from the arrangement 4 to the block 12 with the heat emission member 11. Preferably, the return duct 9 is provided with a bleeder 22, for example of the Indianna-type.

These ducts 9, 26 can for example have a diameter of approximately 12 mm and can advantageously be produced from flexible PVC, and can be provided with insulation. The diameter of the ducts 9, 26 mainly depends on the type of cooling block 12 used and can therefore be more or less than the mentioned 12 mm, such as between 10 and 20 mm.

The heat emission member 11 is cast in a schematically depicted block 12 (for example of a heat conductive material such as aluminum). This results in a much more compact construction than in installations as in use up to now, and efficient cooling. The supply duct 26 that runs from the cooling block 12 to the beverage dispensing arrangement 4 can otherwise have an advantageous length of 6 m, such that the cooling device 1 does not require too close a placement to the beverage dispensing unit 19, for example in a drinks establishment, nor requires placement that far away from the beverage dispensing unit 19 that unnecessary energy losses occur. However, the supply ducts 26 can have a greater length (up to 60 m). The person skilled in the art will understand, however, that energy losses will increase as duct length increases.

When a fluid substance is used, the cooling block 12 can advantageously be provided with a synthetic or metal casing, such that leaking or oxidation is prevented as much as possible.

The coolant circuit 2 is preferably configured in such a away that pressure in the duct 9 running to the beverage dispensing arrangement 4 is approximately 2.5 bar. Also, an expansion tank 16 is arranged in the coolant circuit 2, which expansion tank can have a volume of approximately 8 l.

Also, a refrigerant circuit 3 is arranged in the block 12 that comprises the evaporator 13. The heat emission member 11 dissipates heat from the coolant circuit 2 via the cooling block 12, for example an aluminum cooling block, to this evaporator 13. Both the heat emission member 11 and the evaporator 13 can comprise ducts that are arranged in the cooling block 12 in a zigzag pattern, in such a way that an as large as possible thermal contact surface is obtained. The duct of the evaporator 13 preferably is made of stainless steel when the cooling block 12 is made of aluminum. Consecutively, in the refrigerant circuit 3, downstream of the evaporator, a suction-refrigerant duct 18, a compressor 14, a hot gas refrigerant duct 27, a condenser 15, a fluid refrigerant line 24, a dryer 25, an expansion tank 17, for example in the form of a capillary, are arranged. The condenser 15 can for example be constituted by a copper duct formed in a zigzag pattern, whose back-and-forth duct parts preferably run parallel and are connected by metal bars. The advantage of these bars, with respect to for example strips or cooling fins, is that relatively little ambient dust settles on the bars, which increases the cooling capacity of the condenser 15 and further reduces energy consumption. Preferably, the compressor 14 is frequency-controlled. The refrigerant can advantageously be of the type R290. The condenser 15 can comprise a type 156-condenser as supplied by the Kissmann company.

In practice, with the embodiment as shown in FIG. 1, when cooling a beverage dispensing arrangement 4 for use with beer wherein a “beer pillar” with ice is formed, energy savings of approximately 30-70% with respect to the known cooling devices operating with an open type of cooling arrangement can be achieved.

FIG. 3 shows a cut-away, perspective view of a second exemplary embodiment of a cooling device 1 according to the invention wherein two (not shown) beverage dispensing units 19a, 19b can be connected for dispensing a beverage, such as beer, with different temperatures, especially a first beverage having a temperature of 0° C. at dispensing and a second beverage having a temperature of below 0° C. at dispensing, for example −7° C. Otherwise it is conceivable that both beverages have a temperature above or below 0° C.

FIG. 3 shows a cooling device 1 having the shape of a horizontal beam, wherein several parts of both the coolant circuit and the refrigerant circuit are arranged, such that a compact installation is obtained. Essentially, the cooling device as shown is divided into three compartments: a left side compartment 31, wherein “active” parts of both the coolant circuit, such as the coolant pump 10, and the refrigerant circuit 3 are housed, a middle compartment 33, wherein a cooling tank 28 is placed and a right side compartment 32, wherein an expansion tank 29 is placed. In the exemplary embodiment as shown, this expansion tank 29 has a volume of approximately 5-20 l, preferably 17 l, and can be filled with a refrigerant of the R290 type, also known as propane. Other, similar refrigerants can also be used. The cooling tank 28 approximately has a cubic shape and is attached to, for example by means of suspension, to four vertical corner profiles 30, for example having an L-shaped cross-section as shown. It is also conceivable, as the person skilled in the art will understand, that the cooling tank 28 is arranged in the cooling device in a different way, such as resting upon a bottom plate (not shown) of the cooling device. The side compartments 31, 32 are also provided with vertical corner profiles 30 in their corners.

The heat exchanger in the form of the cooling block 12 is arranged in the centre of the cooling tank 28. The cooling block 12 has a vertically extending, beam-like shape. On the upper back side of the cooling tank 28 as shown in FIG. 3, two beverage ducts 7, such as beer ducts, are arranged. Otherwise, both the application of a single beverage duct 7 and the application of multiple beverage ducts 7 is conceivable. Of each pair of beverage ducts 7 as shown in FIG. 3, which ducts 7 can for example run parallel to each other, one duct is arranged for transporting the beverage to be cooled from a pump 6 to the cooling tank 28 and a neighboring duct is arranged for transporting cooled beverage to one of the respective beverage dispensing units 19a, 19b. In the cooling tank 28, the beverage in the ducts 7 is cooled to for example 0° C. The beverage ducts 7 are arranged in the cooling tank 28 in a coil, for example near the side walls of the cooling tank 28 as shown, to create sufficient cooling surface area for heat exchange, i.e. cooling. The cooling block 12 is situated in the centre of the coil, i.e. on the main axis thereof. The coil windings thus run around the cooling block 12, as a result of which efficient use can be made of the space in the cooling tank 28. The length of the beverage duct 7 is preferably chosen such that the cooled beverage volume in the ducts comprises multiple to-be-dispensed units, such as glasses, of beverage.

From the coolant pump 10 in the left side compartment 31 a coolant duct 2c runs vertically upwards and subsequently horizontally, parallel to the upper side of the cooling tank, towards the top side of the cooling block 12. Before the coolant duct 2c enters the block 12 it branches off into two ducts 2a and 2b. The duct 2a is used for cooling the first beverage dispensing unit 19a and duct 2b for cooling the second beverage dispensing unit 19b. As the beverage dispensing unit 19b is cooled deeper than beverage dispensing unit 19a, the duct 2b has a larger total contact surface within the cooling block 12 and with the cooling block 12 to achieve a greater degree of cooling of the coolant flowing towards beverage dispensing unit 19b, such that at the second beverage dispensing unit 19b colder coolant can be dispensed than with the first beverage dispensing unit 19a. To this end, within the cooling block 12 the duct 2b can be provided with more windings than the than the duct 2a. The ducts 2a, 2b run vertically upwards after cooling by the cooling block 12. Next to the ducts 2a and 2b extending vertically from the cooling block 12, two return ducts 9a and 9b are arranged in a pair-wise fashion. The ducts 9a and 9b originate from the respective beverage dispensing units 19a, 19b. Above the cooling block 12 these ducts 9a, 9b converge to form a single return duct 9. This return duct 9 substantially runs horizontally, parallel to the upside op the cooling tank 28, into the left side compartment 31, after which the duct 9 extends vertically downwards in the direction of the coolant pump 10. The refrigerant ducts 3, 18, 27 runs substantially parallel to the ducts 2 of the coolant circuit 2 from and to the cooling block 12.

As will be understood, more beverage dispensing units can be connected to the cooling device, if desired, wherein the total contact surface in the cooling block 12 can be configured to adjust the degree of cooling of the coolant for an individual beverage dispensing unit. Additionally, it is conceivable that the cooling device is used for cooling electrical cabling, data cabling, fluid ducts, gas ducts, and the like, or for cooling skating rinks, buffets and the like.

Furthermore, it is conceivable that the cooling block is arranged or incorporated in a space to be cooled, instead of in a cooling tank.

With the combined cooling device 1 as described in FIG. 3 energy savings of approximately 40-50% can be realized with respect to separate cooling devices for, respectively, a deep-cooled, such as frozen, beverage dispensing unit and a less deeply cooled beverage dispensing unit.

FIG. 4 schematically shows a coolant circuit 2 according to the second exemplary embodiment with beverage dispensing units 19a, 19b that can dispense beverage, in this case beer, at different temperatures. FIG. 4 schematically shows the elements of the coolant circuit 2 as discussed with reference to FIG. 3.

FIG. 5 schematically shows the heat exchanger 12 as used in the cooling device 1 according to the second exemplary embodiment. During operation of the compressor 14 the heat exchanger in the form of the cooling block 12 is cooled in such a way that ice develops at the outside of the cooling block 12. This ice subsequently assists with cooling water in the cooling tank 18 until approximately 0° C., and to keep it cooled. The beverage ducts 7 are in contact with the water and have such a contact surface that the beverage is cooled until or near 0° C.

FIG. 6 schematically shows a cooling device 1 according to the second exemplary embodiment, wherein two beverage dispensing units 19a, 19b are shown that can dispense beverage at different temperatures, more specifically at a temperature of respectively 0° C. and a temperature of approximately −7° C., at which temperature the beverage is still fluid. The cooling device 1 can be installed relatively easily in a drinks establishment, under a bar, wherein two beverage dispensing units 19a, 19b are positioned above the cooling device.

FIG. 7 schematically shows a cooling device wherein the refrigerant circuit is arranged for offering the possibility of melting away excess ice from the cooling block 41a in the cooling tank 41. To this end, the heating element 42 is arranged in the cooling tank 41, near or at the cooling block 41a. This heating element 42 is connected to a suction gas duct G at an inlet side and to a fluid duct D at an outlet side. In the following description, further parts of the cooling device will be discussed with reference to the cooling device during operation.

In a freezing mode, the three-way valve finds itself in such a position that the refrigerant is pumped through the hot gas duct A and the hot gas duct B to the condenser 44 by means of the frequency-controlled compressor 43. The refrigerant subsequently condenses in the condenser 44. A condenser fan 45 is coupled to the condenser 44 to transport heat emitted by the condenser away there from by means of convection. From that position the refrigerant is transported through the fluid ducts H and E to the dryer 46. A check valve 50 prevents refrigerant from flowing from the fluid duct E into the fluid duct D. Then the refrigerant is pumped to the cooling block 41a in the cooling tank 41 via the capillary duct F to exert its cooling action there. Due to this cooling action ice formation occurs on the cooling block 41a. Subsequently, the refrigerant is ‘sucked back’ via the suction gas duct G to the compressor.

In a thaw mode the three-way valve 47 is put in such a position that the refrigerant, instead of towards the condenser 44, is diverted to the heating element 42 via suction gas duct G. The condenser fan 45 is turned off then. When the refrigerant flows through the heating element 42 heat is passed to the cooling tank 41, as a result of which excess ice in the cooling tank 41 is molten away. Subsequently, the refrigerant in fluid form is transported to the dryer 46 via fluid ducts D and E. The two-way valve 49 furthermore is configured in such a way that refrigerant is prevented from being transported to the condenser 44. Consecutively, the refrigerant, just like in the thaw mode, is led through the cooling tank 41 and the compressor 43, after which the three-way valve 47 is reached again. In the hot gas duct C, that is arranged between the three-way valve 47 and the heating element 42, a two-way valve 48 is otherwise arranged to control the flow direction there in the two modes.

In the thaw mode, the heating element 42 thus uses heat already present in the refrigerant circuit, which heat would normally be expelled via the condenser 44, but is used now to melt excess ice on the cooling block 41a. As the man skilled in the art will understand, it is also possible for the heating element 42 to comprise an electric heating member, such as a heating spiral.

Besides, the cooling device can be used to cool a space/volume. Therein, the heating member 42 is used to warm that space.

FIG. 8 schematically shows another exemplary embodiment of the cooling device 1 with a cooling tank 60 with cooling water 68. The cooling tank 60 is furthermore provided with a removable, isolated lid 71 on top to seal the cooling tank 60. A mounting plate 70, having a cooling block 63 mounted thereto, is attached to the lower side of the lid 71. Within the cooling block 63 a carbonator 61 is arranged, the carbonator 61 being separated from the cooling block 63 by a layer 62. The layer 62 can be an isolating layer, in case of the temperature of the block 63 being too low for proper carbonation. Otherwise, the layer 62 can be a heat conducting layer, when the temperature of the block is equal to the ideal temperature for carbonation. The layer 62 can also comprise a material suitable for dampening temperature changes occurring within the cooling block 63. The top part of the carbonator 61 is provided with a water inlet 74, a CO2-inlet 72 and a carbonated water outlet 73. Furthermore, a coolant circuit having an inlet 64 and an outlet 67 is shown running through the cooling block 63. Analogously, an evaporator circuit having an inlet 65 and an outlet 66 is shown, arranged in the cooling block 63. Preferably, the evaporator circuit is arranged near the outer parts of the cooling block 63 to prevent the carbonator 61 from freezing.

The energy efficient cooling mechanism of the cooling device 1 is thus also put to good use for producing cool, carbonated water. An additional advantage concerns the fact that significantly more CO2 dissolves in cool water, causing the cooling device to be able to produce carbonated water with a sparkly, refreshing taste.

The carbonated water is then transported to a tap (not shown), which can also be cooled by the coolant circuit, where it is mixed with, for example, syrup to obtain the final beverage to be served to a customer. If desired, the coolant circuit can also be used to cool such syrups, before mixing them with the carbonated water.

### REFERENCE NUMERALS

1. Cooling device

2. Coolant circuit

2a. Coolant duct in/from heat exchanger to (cooled) beverage dispensing unit

2b. Coolant duct in/from heat exchanger to (frozen) beverage dispensing unit

2c. Coolant duct from coolant pump to heat exchanger

3. Refrigerant circuit

4. Beverage dispensing device

5. Beverage tank

6. Beverage pump

7. Beverage duct

9. Coolant duct (return duct)

9a. Coolant duct from (cooled) beverage dispensing unit to coolant pump

9b. Coolant duct from (frozen) beverage dispensing unit to coolant pump

10. Coolant pump

11. Heat emission member

12. Cooling block

13. Evaporator

14. Compressor

15. Condensor

16. Expansion tank

17. Expansion member

18. Refrigerant duct (suction gas)

19. Beverage dispensing unit

19a. Beverage dispensing unit (cooled)

19b. Beverage dispensing unit (frozen)

22. Bleeder

24. Refrigerant duct (fluid)

25. Dryer

26. Coolant duct (supply duct)

27. Refrigerant duct (hot gas)

28. Cooling tank

29. Expansion tank

30. Corner profile

31. Left side compartment

32. Right side compartment

33. Middle compartment

41. Cooling tank

41a. Aluminium block, glycol tank

42. Hot gas thaw

43. Frequency-controlled compressor

44. Condensor

45. Condensor fan

46. Dryer

47. Three-way valve

48. Two-way valve

49. Two-way valve

50. Check valve

51. Check valve

60. Cooling tank

61. Carbonator

62. Layer between carbonator and cooling block

63. Cooling block

64. Coolant circuit (inlet)

65. Evaporator (inlet)

66. Evaporator (outlet)

67. Coolant circuit (outlet)

68. Water in cooling tank

69. Isolated outer wall of cooling tank

70. Mounting plate for cooling block

71. Isolated lid

72. Inlet CO2 carbonator

73. Outlet carbonated water

74. Water inlet

1-18. (canceled)

19. Cooling device (1), provided with:
a closed coolant circuit (2) for cooling a volume, such as a cold store, or an arrangement (4), such as a beverage dispensing unit (19, 19a, 19b), comprising a pump (10) for pumping a coolant through the coolant circuit (2), and a heat emission member (11) provided in the coolant circuit (2) for emitting heat absorbed by the coolant circuit (2) from the volume or the arrangement (4), wherein the heat emission member (11) is in heat exchanging communication with an evaporator (13) of a closed refrigerant circuit (3), the refrigerant circuit (3) being a different circuit than the coolant circuit (2), wherein the heat emission member (11) of the coolant circuit (2) and the evaporator (13) of the refrigerant circuit (3) are connected in a heat exchanging manner by means of a heat conducting substance (12), such that the refrigerant circuit (3) is used to achieve cooling of the coolant circuit (2) or the heat-conducting substance (12), wherein the refrigerant circuit (3) therein is capable of achieving lower temperatures than the coolant circuit (2), characterized in that the heat conducting substance (12) comprises a metal body in which the heat emission member (11) and the evaporator (13) are embedded, the metal of the metal body being configured for conducting heat from the heat emission member (11) to the evaporator (13), wherein, during use, the heat conducting substance (12) is suspended in a water body of a water-containing tank (28, 41, 60), in such a way that the water is cooled by the heat conducting substance (12).

20. Cooling device (1) according to claim 19, wherein the metal body is made of aluminum.

21. Cooling device (1) according to claim 19, wherein the evaporator (13) comprises duct parts (18) contained in the metal body (12), which duct parts (18) are made of stainless steel.

22. Cooling device (1) according to claim 19, wherein the coolant circuit (2) is configured to cool a beverage dispensing unit (19, 19a, 19b).

23. Cooling device (1) according to claim 19, wherein the coolant circuit (2) is configured to distribute coolant at different temperatures to different volumes or arrangements (4).

24. Cooling device (1) according to claim 23, the coolant circuit (2) comprising several duct parts (2a, 2b, 2c, 9, 9a, 9b), a duct part (2c) for delivering coolant to be cooled to the heat emission member (11), this duct part (2c) branching off into a plurality of ducts (2a, 2b), wherein the heat emission member (11) comprises a plurality of heat emission member parts corresponding to the plurality of branched-off duct parts (2a, 2b), each heat emission member part being associated with one of the branched-off duct parts (2a, 2b), the heat emission member parts having a different degree of heat exchange with the heat conducting substance (12), such that the coolant in the duct parts (2a, 2b) is cooled to different temperatures by the heat conducting substance (12).

25. Cooling device (1) according to claim 24, wherein the different degree of heat exchange is achieved by configuring the ducts parts (2a, 2b) to be the heat emission member (11) parts by letting them directly emit heat to the heat conducting substance (12), wherein the total surface area of the duct parts (2a, 2b) exchanging heat with the heat conducting substance (16) differs to obtain coolant having different temperatures.

26. Cooling device (1) according to claim 25, wherein the coolant circuit (2) is configured to cool dispensing units, and one duct part (2a) of the plurality of duct parts (2a, 2b) delivers coolant to a first beverage dispensing unit (19a) to be cooled at a first temperature, and another duct part (2b) of the plurality of duct parts (2a, 2b) delivers coolant to a second beverage dispensing unit (19b) to be cooled at a second temperature.

27. Cooling device (1) according to claim 26, wherein the first temperature is above 0° C., and the second temperature is below 0° C., such as approximately −7° C.

28. Cooling device (1) according to claim 22, wherein the beverage dispensing unit (19, 19a, 19b) is connected to a beverage supply duct (7), the beverage supply duct (7) being at least partly arranged in the water body of the water-containing tank (28, 41, 60), such that the beverage is cooled by the water body.

29. Cooling device (1) according to claim 19, wherein, during use, a heating element (42) is arranged in the water body, the heating element (42) being connected to a part of the refrigerant circuit (3) containing hot fluid or gas, in such a way that, when ice is formed on the heat conducting substance (12) due to freezing water, the heating element (42) can be activated to raise the temperature of the water using heat from the refrigerant circuit (3) in order to cause the ice to thaw.

30. Cooling device (1) according to claim 19, wherein the heat conducting substance (12) is a vessel comprising a heat conducting fluid, such as glycol.

31. Cooling device (1) according to claim 19, wherein a carbonator (61) is arranged in the heat conducting substance (12), the carbonator (61) being connected to a beverage supply duct (7) and a CO2-supply duct, and a discharge for discharging the carbonated beverage after carbonation in the carbonator (61), wherein the carbonator (61) is cooled by the heat conducting substance (12).

32. Cooling device (1) according to claim 19, wherein the coolant circuit (2) is provided with transport taps and service taps.
